(19) United States
(12) Patent Application Publication
(10) Pub. No.: US 2022/0297827 A1
(43) Pub. Date: Sep. 22, 2022

(54) An Electromagnetically-Actuated Rim Driven Hubless Fan with a Single Stage and Non-Magnetic Bearings

(71) Applicant: EMBRAER S.A., Sâo José dos Compos-SP (BR)

(72) Inventors: Alysson Kennerly COLACITI, São José dos Campos-SP (BR); Thiago Rodrigo LOSS ZMIJEVSKI, São José dos Campos-SP (BR)

(21) Appl. No.: 17/695,375

(22) Filed: Mar. 15, 2022

Related U.S. Application Data
(60) Provisional application No. 63/163,352, filed on Mar. 19, 2021.

(51) Int. Cl. B64C 27/20; B64D 31/00; B64D 27/24; B64C 11/00; B64C 11/18; B64C 27/467

(52) U.S. Cl. CPC B64C 27/20; B64D 31/00; B64D 27/24; B64C 11/001; B64C 11/18; B64C 27/467; B64D 2027/026

(57) ABSTRACT

A brushless DC motor is integrated with an aeropropulsive thrust generator that is hubless, not in tandem (co/counter) rotating propeller disks, and not having magnetic bearings.

### CROSS-REFERENCE TO RELATED APPLICATION

This application claims benefit of Application No. 63/163,352 filed 03-19-2021, which is incorporated herein by reference in its entirety and for all purposes.

### FIELD

The technology herein relates to the field of hybrid-electric propulsion systems for aeronautical application.

### BACKGROUND & SUMMARY

Thanks to its simplicity and compact size, multi-rotors became popular in recent years enabling low emissions aircraft with vertical takeoff and landing (eVTOL) capability. Basically, a multi-rotor aircraft has more than one rotor, which provides redundancy and stability. There have been many attempts to design efficient, reliable rotors for such aircraft.

Despite their limited endurance, most of the pure electric type of multi-rotors have in common the following architecture: battery—engine controller—brushless DC motor—aeropropulsive thrust generator (airscrew and, optionally, duct or shroud). For example, allowing some deterioration of the vehicles' simplicity and size, ducted fans and shrouded propellers are aeropropulsive candidates (amongst others) capable of improving these vehicles' endurance and enhanced low noise performance. See for example U.S. Pat. No. 1,993,158. A simple way to achieve this is by assembling a structure with aerodynamic function surrounding rotating blade(s) and an inlet capable of aerodynamically driving air into the system. Fixation struts hold a brushless DC motor at the center of the duct. Aerodynamic drag of these struts creates energy loss.

The aeropropulsive thrust generator type that provides most vehicles' simplicity and compact size is the fixed pitch airscrew. An airscrew is a rotational device that moves a vehicle in a direction by pushing air in the opposite direction—much as a common woodscrew drives itself further into wood when its angled threads push on the wood in an opposite direction. Leonardo da Vinci drew a human-powered helical air screw design in the 15^{th} Century. More modern fixed pitch airscrews comprise blades that are fixed to their hub at an angle called pitch angle. The pitch angle determines how much thrust the airscrew provides (i.e., how much air it pushes) and correspondingly, how much force is required to turn the airscrew. Meanwhile, variable pitch air screws are used to account for different engine rotational speeds. See e.g., Smith, “Evolution of the Variable Pitch Air Screw” (Flight Aug. 14, 1941).

Those skilled in the art know that the fixed pitch airscrew solution has limited performance due to the existence of a blade tip at the region of most thrust contribution (maximum dynamic pressure). See e.g., Ragni et al, “3D pressure imaging of an aircraft propeller blade-tip flow by phase-locked stereoscopic PIV”, Experiments in Fluids, Volume 52, pages 463-477 (2012), DOI 10.1007/s00348-011-1236-6. This aeropropulsive thrust performance is one of the drivers of the vehicles' endurance.

From the structural perspective, due to manufacture tolerances, strain and vibration of the system components, the existence of a tip gap between the blade tip and the surrounding duct is important to avoid wearing, structural collapse, and crash or jamming of the rotating blade(s) with the duct. It is common knowledge that the performance of this architecture is very dependent on the tip gap. On the one hand: the smaller tip gap, the better performance; and on the other hand: the smaller the tip gap, the heavier the system gets, e.g., due to additional structure needed to avoid catastrophic degradation allowing the rotating blade tip to contact the surrounding shroud or other structure. Such additional structural mass can interfere with becoming more robust, reducing strain and avoiding wearing, structural collapse, etc.

In an elegant form, rim driven fans re-imagine the architecture of the ducted fans with the potential to overcome their constructive drawbacks. By driving the rotating blades from the outer rim, the power system no longer needs to be placed at the center of the propulsive assembly and the tip gap vanishes when the blades are structurally fixed at the rotating shroud. Many published patents record technology with architectures that are similar to some extent. Generally speaking, these solutions are suitable for marine applications once their propulsive power are driven hydraulically, mechanically (gears), or using an induction motor (synchronous rotation). Some such solutions even claim the existence of a hub at the inner center of the propulsive system assembly.

However, for aeronautical applications, the capability to change the rotational speed of the propeller is a key functionality to control flight of an aircraft/rotorcraft. Weight and efficiency are crucial for aeronautical application and, thus, these prior solutions are limited in that regard.

Lift fans were studied and successfully installed in aircraft during past defense programs as shown in NASA Technical Report “The Lift-Fan Aircraft: Lessons Learned”, by Wallace H. Deckert (NASA Contractor Report 196694 1995). In typical past applications, gas generators powered rim driven lift fans by pneumatic means, proving the feasibility of this solution to allow vertical takeoff and landing capability even with the typical efficiency-limited thermodynamic power-driven system.

Some published patents are more aeronautical suitable solutions despite limited application on eVTOL aircraft. Counter rotating tandem propeller disks add complexity to this system and require longer ducts, which deteriorate cruise flight performance for eVTOL aircraft. Additionally, for brushless DC motor driven propeller disks, in order to actuate two disks in tandem there are several electromagnetic interaction effects that need to be addressed. Many patents and prior approaches also claim the adoption of magnetic bearings which, for the same reason, have undesired electromagnetic interaction effects when the rotating propeller disk are brushless DC motor driven.

A terrain vehicle is also known where the rim driven ducted fan is contained within a terrain wheel (peripheral ground-engagement part).

Thus, despite much work in the past, further improvements are possible and desirable.

### BRIEF DESCRIPTION OF THE DRAWINGS

FIG. 1 shows a rotating shroud (movable primary structure) with a set of 5 blades.

FIG. 2 shows a fixed primary structure with provisions to place the (hidden) coils and (hidden) high-speed bearings suspension system.

FIG. 3 shows an application case of secondary structures attached to the fixed primary structure (the bottom panels are hidden to improve visibility).

FIG. 4 shows an assembled system as seen from the inlet.

FIG. 5 shows an example non-limiting block diagram.

FIG. 6A shows an example non-limiting use of the aeropropulsive thrust generator embodiments on a CTOL aircraft.

FIG. 6B shows an example non-limiting use of the aeropropulsive thrust generator embodiments on a non-winged eVTOL aircraft.

FIG. 6C shows an example non-limiting use of the aeropropulsive thrust generator embodiments on a winged VTOL aircraft.

### DETAILED DESCRIPTION OF NON-LIMITING EMBODIMENTS

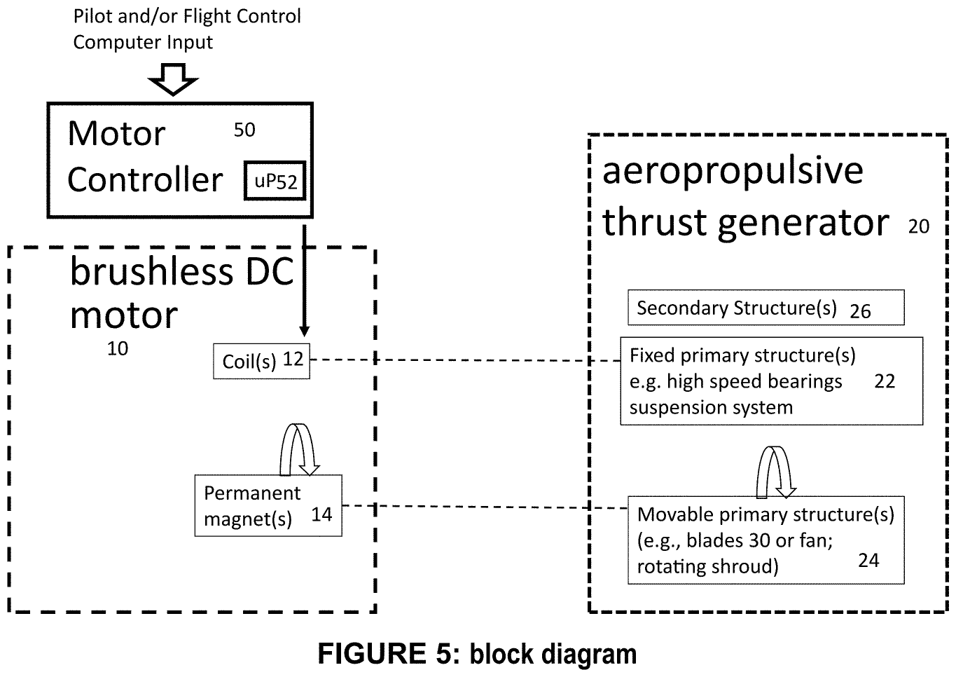

In order to come up with a competitive aeronautical application, including but not limited to modern multi-rotors hybrid-electric type electric vertical take-off and landing (eVTOL) aircraft, an example aeropropulsive thrust generator 20 comprises the following basic elements: a motor controller 50 which controls a brushless DC motor 10; and an aeropropulsive thrust generator 20 (see FIG. 5 block diagram of an example non-limiting propulsion system). The example embodiment is hubless; not in tandem (co/counter) rotating propeller disks; and not having magnetic bearings.

As FIG. 5 shows, the components are split in two functional groups: electromagnetics and structural. The coils 12 and permanent magnets 14 are brushless DC motor 10 parts with electromagnetic functions. The structural parts are the fixed and movable primary structures 22, 24 as well as blade(s) 30 and secondary structures 26. The interface between fixed and movable primary structures 22, 24 exchanges power (by an electro-magnetic means), forces and moments by a high-speed bearings suspension system which holds the movable primary structure 24 allowing it to rotate only around the designed rotation axis relative to the fixed structure 22. The movable primary structure 24 is equipped with (fan/propeller) blade(s) 30 with an aerodynamic function to convert its rotational movement into thrust.

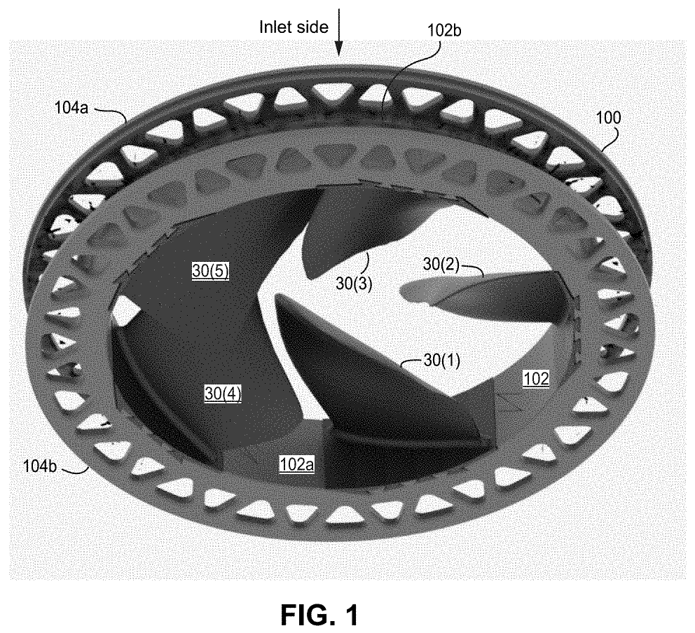

As will become clear from the below explanation of FIGS. 1-4, the blocks shown in FIG. 5 represent interdependent structures. For example, the brushless DC motor is not necessarily separate and distinct from the aeropropulsive thrust generator 20. Rather, in one embodiment, components of the brushless DC motor 10 and components of the aeropropulsive thrust generator 20 may be combined in the same overall structure. For example, in one embodiment the coils 12 may be stationary and disposed on a fixed primary structure 22 which functions as a stator for the electric motor, and the permanent magnets 14 may be moving and disposed on a movable primary structure 24 which functions as a rotor for the electric motor.

In more detail, the structural conception of an example embodiment begins with a fixed primary structure 22, which is linked to the vehicle, exchanging forces and moments between the propulsion system and the vehicle. The fixed primary structure 22 will host the following example components:
Brushless DC motor coil (electromagnetic) 12 winding or windings produce a rotating magnetic field to drive rotation of permanent magnets 14 attached to the movable primary structure 24;
Non-magnetic high-speed bearings suspension hold the movable primary structure 24 in place allowing it to rotate around the designed rotation axis relative to the fixed primary structure 22 (the non-magnetic suspension may comprise for example a hydrodynamic suspension or a pneumatic suspension or ball bearings, depending on the application);
Aerodynamic secondary structures 26 (e.g., fairings) provide a smooth fluid flowing through the inlet and an exhaust nozzle.

In one example, the example structural conception includes a movable primary structure 24 comprising a rotating shroud (also with Aerodynamic functionality; see FIGS. 1-4) that will host the following components:
Brushless DC motor permanent magnets 14 (which will receive and be magnetically propelled by the magnetic field generated by the coils/windings)
Aerodynamic blade(s) 30 which will convert the rotational movement into thrust by forcing the air to flow from the inlet to the exhaust nozzle.

As noted, in one embodiment the coils 12 are fixed to the fixed primary structure 22 (located inside the aerodynamic fairings void) making out of the airframe multiple functions. The permanent magnets 14 are fixed to the movable primary structure 24 (rotating shroud of FIGS. 1-4). The rotating shroud 24 slides over high-speed bearing suspension systems, installed to the fixed primary structure 22.

In this regard, FIG. 1 shows a rotating shroud 100 (movable primary structure 24) with a set of blades 30 (5 blades in this example) attached to an inner circumferential surface 102a of the shroud.

The rotatable shroud 100 has an aerodynamically designed rotating shape. Thus, as can be seen in FIG. 1, the example non-limiting thruster embodiment includes a rotatable circular shroud 100 in the shape of a wheel. In one embodiment, shroud 100 preferably comprises a cylinder 102 having an inwardly facing cylindrical surface 102a and an outwardly facing cylindrical surface or rim 102b. However, the rotatable shroud 100 can comprise a rotating spline around a rotating axis. In one embodiment, the inwardly and outwardly facing cylindrical surfaces of rotatable shroud 100 meet in upper and lower rim edges. Circular tracks 104a, 104b extend outwardly from the upper and lower rim edges, respectively. The circular tracks 104a, 104b have cutouts about their surfaces to reduce weight and mass while providing high strength. The rotatable shroud 100 cylinder's inwardly-facing surface 102a defines an inner cylindrical space centrally within the shroud. There is no hub, axle or commutator within this center space. A plurality (e.g., five) blades 30 are disposed on the inwardly-facing surface 102a. The blades 30 are directed inwardly from the inwardly-facing surface 102a and are shaped and dimensioned so they do not touch or interfere with one another. In one embodiment, the blades are stationary relative to one another, i.e., they do not move relative to one another. The blades 30 in this embodiment thus have a fixed pitch—although in some embodiments it might be possible for the blades to have variable pitch so long as the blades do not mechanically interfere with one another. In the example shown, referring to aerodynamic twist of the blades 30, the blades curve inwardly away from an inlet side of the thruster as the blades approach the center of the circular space defined with the shroud 100.

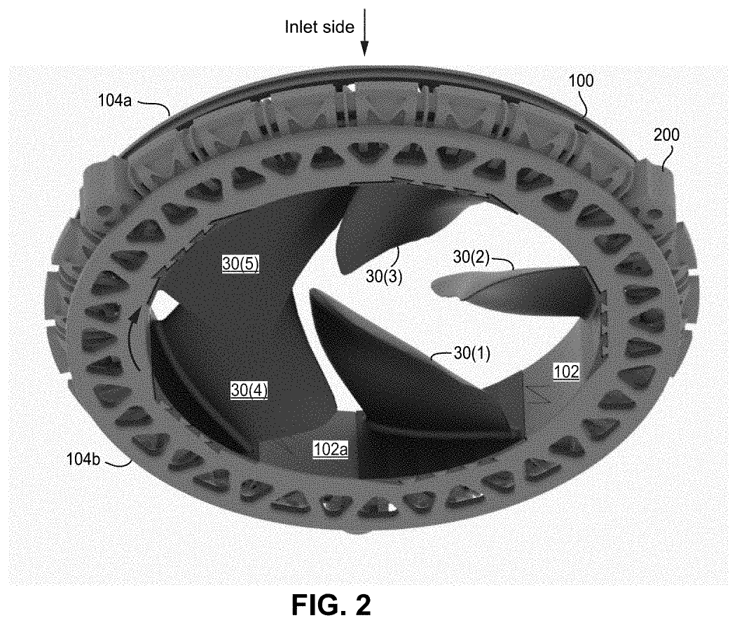

FIG. 2 shows the same rotatable circular shroud 100 to which is added a fixed primary structure 200 with provisions to place the (hidden) coils 12 and (hidden) high-speed bearings suspension system. In one non-limiting embodiment, the fixed primary structure 200 is mounted between the outwardly extending tracks 104a, 104b and interfaces with and supports an outer cylindrical surface of the shroud 100 with the high-speed bearings suspension system, thus enabling the shroud to rotate relative to the fixed primary structure 200 about the imaginary central axis of the cylinder the shroud defines with low friction while retaining the shroud so it does not escape or wobble about its axis.

In one embodiment there is only one stage to the propulsor, i.e., there is no second or third layer or level of blades nor is there a second rotatable shroud.

The brushless direct current motor is integrated within the rotatable shroud 100, with the rotatable shroud serving as the rotor of the motor, i.e., permanent magnets 14 are mounted on the rotatable shroud and are subjected to magnetic lines of force produced by coils 12 of a surrounding stationary stator 200 of the motor. A motor controller 50 supplies changing current of appropriate polarities to produce a rotating or alternating magnetic field to drive the magnet-laden shroud 100 to rotate on its high speed bearings suspension system in a desired direction at a desired speed. The fixed primary structure 200 meanwhile is attached to an aircraft so that motion the rotating shroud 100 imparts to the fixed primary structure 200 is in turn imparted to the aircraft.

In more detail, as the shroud 100 rotates, the blades 30 draw in air from the inlet side and expel it at the outlet side, thereby generating a forward thrust that pulls the entire assembly toward the inlet side. If the inlet side is up, rotation of shroud 100 generates an upward thrust that can cause a VTOL aircraft to rise.

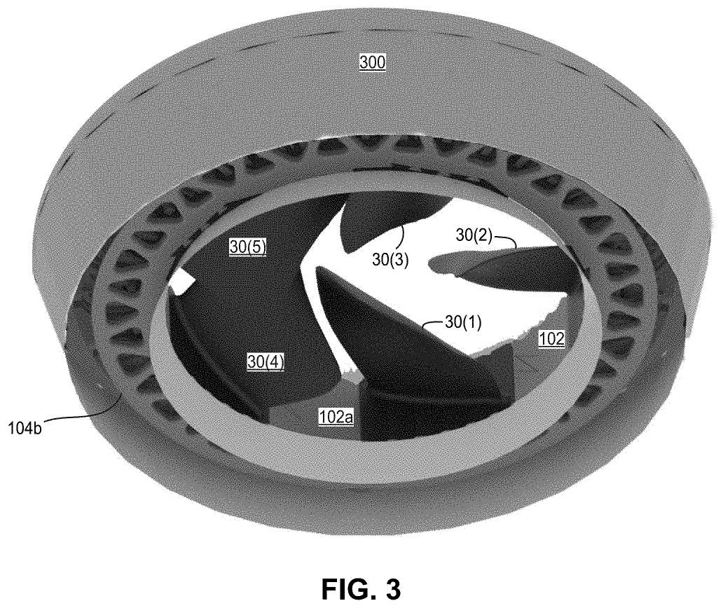

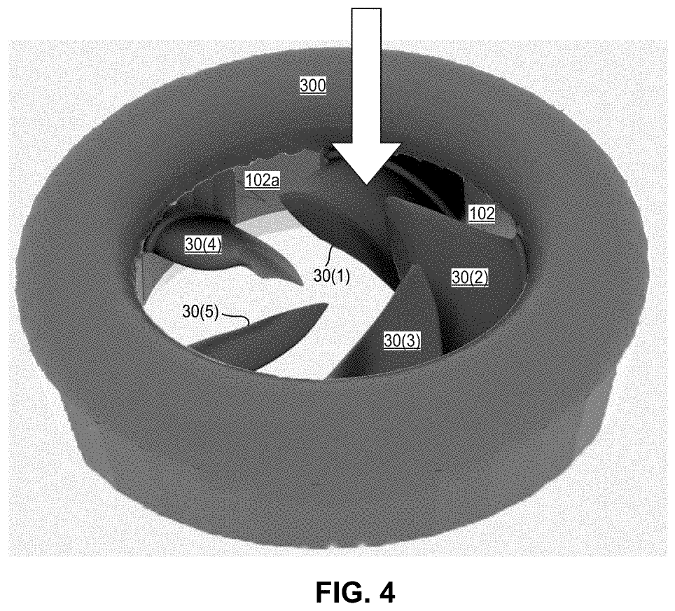

FIG. 3 shows an application case of outer peripheral secondary structures 300 attached to the fixed primary structure 200 (the bottom panels of the secondary structures are hidden to improve visibility). FIG. 4 shows an assembled system as seen from the inlet. The secondary structures 300 in this case comprise a doughnut-shaped shell that houses and protects the components 100, 200 while enabling air to pass from the inlet side through the rotating blades 30 to the outlet side. In one embodiment, the doughnut-shaped shell is fixed to the interior fixed primary structure 200 and includes a mounting structure that allows the shell to be fixed in a desired orientation relative to the fuselage of an aircraft.

The remaining interface between the above and the vehicle are electrical terminals connections which, interfacing with the engine controller 50 (which in this case is a motor controller), will exchange electrical current together with electricity potential interface to maintain a controlled rotating speed, finally producing the desired aerodynamic thrust. A microprocessor (“uP”) 52 performs example control algorithms based on instructions stored in non-transitory memory and executed by a processor of the engine controller may be responsive to control inputs such as pilot or automatically generated commands by a flight control computer, and may be used to control the various structures of the system through electromechanical, electrical and/or hydraulic actuators, switches, or other control mechanisms.

The example non-limiting embodiment can be used on a variety of different kinds of aircraft, for example:

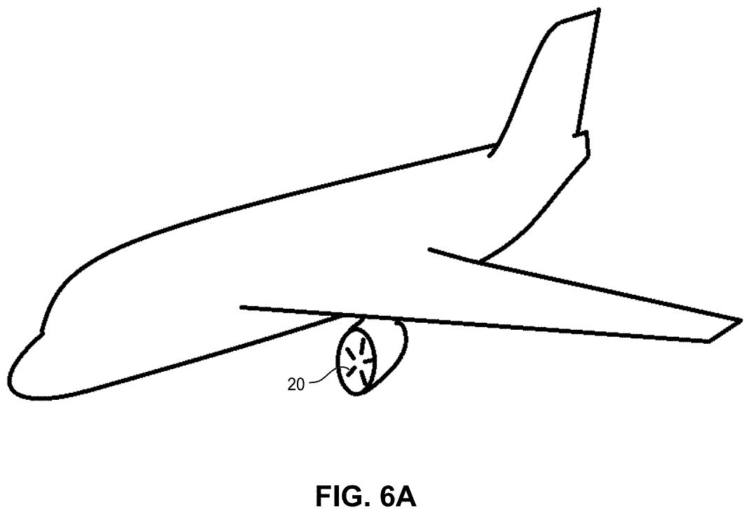

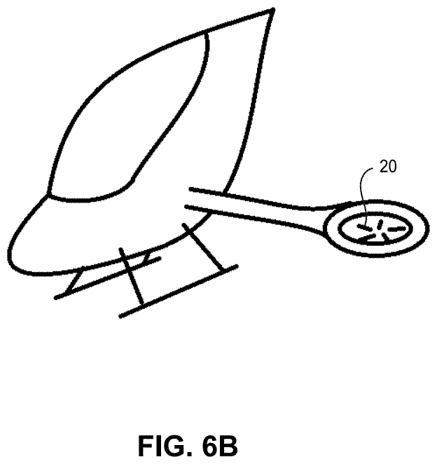

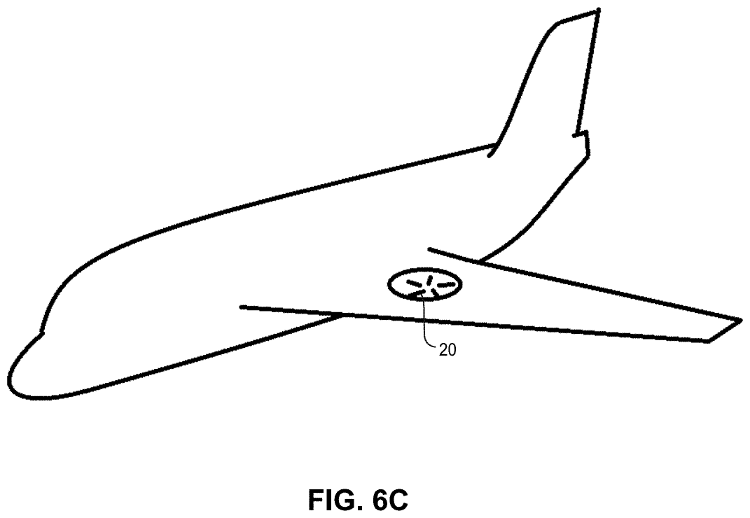

FIG. 6A shows an example non-limiting use of the aeropropulsive thrust generator embodiments on a CTOL aircraft showing a fuselage with a five-sided star representing the aeropropulsive thrust generator 20 oriented vertically under the wing.

FIG. 6B shows an example non-limiting use of the aeropropulsive thrust generator embodiments on a non-winged eVTOL aircraft showing a fuselage with a five-sided star representing the aeropropulsive thrust generator 20 oriented horizontally on a support beam projecting from the fuselage.

FIG. 6C shows an example non-limiting use of the aeropropulsive thrust generator embodiments on a winged VTOL aircraft showing a fuselage with a five-sided star representing the aeropropulsive thrust generator 20 oriented horizontally within a wing part of the fuselage.

All patents and publications cited herein are incorporated by reference.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A hubless propulsor comprising:
a rotatable shroud having a rim that defines an inner space therein, the shroud carrying magnetic elements and blades, the blades projecting from the shroud into the inner space; and
a further structure that supports the shroud rim in such a way that the shroud is rotatable relative to the further structure, the further structure generating a magnetic field that interacts with the magnetic elements carried by the shroud to cause the shroud to rotate relative to the further structure,
wherein the rotating blades generate a thrust.

2. The hubless propulsor of claim 1 wherein the further structure includes electromagnetic coil windings that generate a rotating magnetic field to cause the shroud carrying the magnetic elements to rotate.

3. The hubless propulsor of claim 1 further including a motor controller that supplies controlled current to the electromagnetic coil windings.

4. The hubless propulsor of claim 1 wherein the shroud has an aerodynamically designed rotating shape such as rotating spline around the rotating axis wherein the inner space is cylindrically or other shaped.

5. The hubless propulsor of claim 1 wherein the further structure comprises a non-magnetic suspension that supports the shroud.

6. The hubless propulsor of claim 5 wherein the non-magnetic suspension comprises a hydrodynamic suspension and/or a pneumatic suspension and/or ball bearings.

7. The hubless propulsor of claim 1 wherein the rotatable shroud comprises a cylinder having lips thereon, the cylinder defining an inner circumferential surface, the blades being mounted on the inner circumferential surface and projecting from the inner circumferential surface into a space defined within the inner circumferential surface.

8. The hubless propulsor of claim 1 wherein the blades have an aerodynamic design that is curved away from an inlet side toward an outlet side.

9. The hubless propulsor of claim 1 wherein the hubless propulsor is adapted to provide aeronautical propulsion application and to be mounted to an aircraft or a rotorcraft or a VTOL.

10. The hubless propulsor of claim 1 wherein the propulsor provides an interface between fixed and movable primary structures that exchanges power, forces and moments by a non-magnetic suspension system which retains the movable primary structure allowing it to rotate relative to the fixed primary structure only around a designed rotation axis.

11. The hubless propulsor of claim 1 wherein the propulsor includes a secondary structure that encloses at least part of the rotatable shroud while providing an air inlet and an air outlet.

12. The hubless propulsor of claim 1 wherein the propulsor has no tandem (co/counter) rotating propeller disks.

13. The hubless propulsor of claim 1 wherein the propulsor has no magnetic bearings.

14. A hubless aeropropulsor comprising:
a rotatable shroud carrying magnetic elements and blades, the blades projecting inwardly from the rotatable shroud and positioned to not interfere with or contact one another, the rotatable shroud being structured to rotate in response to a magnetic field; and
a non-magnetic support structure that is part of or is attached to an aircraft fuselage, the non-magnetic support structure supporting the rotatable shroud to rotate relative to the further structure to generate an aerodynamic thrust.

15. The hubless aeropropulsor of claim 14 further characterized in a magnetic field generator that controllably generates the magnetic field to rotate the shroud.

16. The hubless aeropropulsor of claim 14 further characterized that there are at least three blades that curve inwardly to draw air from an inlet side to an outlet side thereby creating the aerodynamic thrust.

17. The hubless aeropropulsor of claim 14 wherein the rotatable shroud and the non-magnetic support structure together comprise a brushless DC motor.
